(19) United States
(12) Patent Application Publication
(10) Pub. No.: US 2010/0088521 A1
(43) Pub. Date: Apr. 8, 2010

(54) PUBLIC ENCRYPTED DISCLOSURE

(76) Inventor: Jeffrey Peck Koplow, San Ramon, CA (US)

Correspondence Address: QUINE INTELLECTUAL PROPERTY LAW GROUP, P.C., P O BOX 458, ALAMEDA, CA, 94501, US

(21) Appl. No.: 12/494,258

(22) Filed: Jun. 29, 2009

Related U.S. Application Data
(60) Provisional application No. 61/076,661, filed on Jun. 29, 2008.

(51) Int. Cl. H04L 9/00; H04L 9/28; H04L 9/08

(52) U.S. Cl. 713/178; 713/150; 380/28; 380/44; 380/278

(57) ABSTRACT

Public encrypted disclosure provides a creation date verification system by making confidential information available in a secure encrypted form that can be decrypted at a later time to verify the existence of the content at the date of the encrypted disclosure. Options provide for various levels of security, verification, and distribution of encrypted content and for automated encryption, submission, and public disclosure of encrypted content.

### CROSS REFERENCE TO RELATED APPLICATIONS

This application claims benefit of priority from provisional application 61/076,661 filed 29, Jun. 2008.

### PRECAUTIONARY REQUEST TO FILE AN INTERNATIONAL APPLICATION AND DESIGNATION OF ALL STATES

Should this document be filed electronically or in paper according to any procedure indicating an international application, Applicant hereby requests the filing of an international application and designation of all states. Should this application be filed in as a national application in the United States, this paragraph shall be disregarded. For the purpose of this designation, any assignee listed on the attached covered page and any inventor listed on the attached cover page are applicants. Applicant is a United States entity.

### COPYRIGHT NOTICE

Pursuant to 37 C.F.R. 1.71(e), applicant notes that a portion of this disclosure contains material that is subject to and for which is claimed copyright protection (such as, but not limited to, source code listings, screen shots, user interfaces, or user instructions, or any other aspects of this submission for which copyright protection is or may be available in any jurisdiction.). The copyright owner has no objection to the facsimile reproduction by anyone of the patent document or patent disclosure, as it appears in the Patent and Trademark Office patent file or records. All other rights are reserved, and all other reproduction, distribution, creation of derivative works based on the contents, public display, and public performance of the application or any part thereof are prohibited by applicable copyright law.

### FIELD OF THE INVENTION

The present invention relates to electronic systems and devices, and methods practiced in part using such systems and to articles of manufacture involved therewith.

### BACKGROUND OF THE INVENTION

The discussion of any work, publications, sales, or activity anywhere in this submission, including in any documents submitted with this application, shall not be taken as an admission that any such work constitutes prior art. The discussion of any activity, work, or publication herein is not an admission that such activity, work, or publication existed or was known in any particular jurisdiction.

Various strategies have been proposed for time-stamped evidentiary disclosure, among them those discussed in the patents and other publications listed on the attached Information Disclosure Statement.

No existing or proposed system has yet provided a strategy that has been widely adopted. Problems of security, ease of use, cost, reliability, and others have all prevented any existing system from being widely adopted for timestamping important confidential information.

The following references are provided by way of reference and as background and are incorporated herein by reference for all purposes: (1) Dolak, L. A. “Patents Without Paper”: Proving date of invention with electronic evidence, Houston Law Review, 36:470 (1999); (2) Hong, J., Toye, G., Leifer, L. J., Personal Electronic Notebook with Sharing, Enabling Technologies: Infrastructure for Collaborative Enterprises, 1996. Proceedings of the 5th Workshop on Publication Date: 19-21 Jun. 1996, ISBN: 0-8186-7446-6; (3) Myers, J. D., Collaborative Electronic Notebooks as Electronic Records: Design Issues for the Secure Electronic Laboratory Notebook. Proceedings of the Fourth Workshop on Enabling Technologies: Infrastructure for Collaborative Enterprises, 1995, ISBN: 0-8186-7019-3.

### SUMMARY

According to specific embodiments, the present invention is involved with methods and/or logic modules and/or systems and/or devices that can be used together or independently to provide a creation date verification system that may be cheaply and easily accessed by authors or owners of confidential information and will be widely accepted as providing uncontestable proof of possession of a media-expressible idea at a certain date without requiring public disclosure of the idea.

One type of information of interest in according to specific embodiments of the invention is evidence. For the purpose of this discussion, “evidence” can be considered any kind of information that provides proof or corroboration of a statement or claim for any purpose. One particular type of evidence of interest according to specific embodiments of the invention is evidence of authorship or invention as of a particular date, or evidence of possession of an idea or data or writing at a particular date. Such evidence can be highly valuable in legal proceedings or other proceedings (such as academic) where priority of invention, discovery, or authorship is important.

For example, one traditional method of documenting the conception of an invention is to have two colleagues not associated with the invention sign and date relevant pages of a laboratory notebook. However, such documentation can easily be fabricated after the fact and widespread use of such fraudulent tactics tends to subvert the original intent of the patent system. Under many circumstances, the greater the value of the intellectual property in question, the greater the potential for such malfeasance. Such evidence tampering (e.g., in a hand-written laboratory notebook) can also be very difficult to detect at a later date.

Thus, according to specific embodiments of the invention, the invention provides a system and method to “time stamp” a document. Desirable characteristics of specific embodiments include, without limitation, one or more of: 1) provides incontrovertible proof; 2) impervious to manipulation, misrepresentation or deceptive practices; 3) does not require actual disclosure to prove precedence; 4) simple to implement; 5) easy to manage from the standpoint of record keeping; 6) generally affordable and inexpensive enough that, once established as a standard practice, non-utilization of the system will make claims of earlier priority in important disputes suspicious; 7) evident to all informed parties that such a system is impervious to influence by any private party or government entity, no matter how powerful; 8) not based on any premise that can be challenged from the standpoint of legal or physical validity; 9) has no significant barrier to its implementation and widespread adoption; 10) can be used by automated systems to provide automatic periodic encrypted disclosure. As described herein, and in the attached claims, embodiments of the invention may have any combination of the above characteristics.

In specific embodiments of the invention, the invention involves a regular preparation of unalterable encrypted media (UaEM) (e.g., an example sometimes referred to herein as The Journal of Public Encrypted Disclosure (JPED)) that, in preferred embodiments, is widely distributed and/or made widely available. For documents such as an invention disclosure or data pertaining to drug discovery, and for any other media, UaEM is used to provide a verification service that can be used for evidentiary purposes in numerous settings.

As an example, consider use of UaEM to time stamp a trade secret for a manufacturing process. In this case, one benefit of disclosure in UaEM is it provides insurance against a future accusation of theft by a competitor who later develops the same manufacturing process. In addition, a UaEM disclosure allows a patent applicant to prove inventorship of such a trade secret, should a patent be pursued.

In a particular implementation, the verification service may be marketed as the “Incontrovertible Time Stamp”™ (ITS™) or as Verification By Decryption At A Later Date™. Generally, such a service will be provided by a business entity acting as a verification service provider, such as the example business entity referred to at times herein as Last Word Archives™ (LWA™). With such a business, for a fee or some other consideration, a customer (or user) can use provided downloadable software (or other software) to encrypt an electronic file (e.g., one containing text and graphics, or video or audio, or an executable file) and transfer it to an encrypted archive database.

In one or more representative embodiments, the encryption software provides a machine-generated encryption/decryption key, such as “H9py-415Wmk8V-90sG-Q7xT-99Jb” which is used to encrypt the document and then securely stored by the client to later provide time-stamp verification through decryption. In one or more further embodiments, the customer then uploads the encrypted document to the archives website (also referred to herein as a server computer system). The customer's encrypted document is stored in a permanent archive of encrypted documents and handled as further described herein.

In a presently preferred embodiment, the encryption/decryption algorithm is known to everyone, but only the customer and any designated trusted agents of the costumer (possibly the verification service provider) knows the encryption key. The encryption algorithm can be any known electronic data encryption algorithm, including, but not limited to, those endorsed by federal agencies such as the National Security Agency (NSA). Other implementations may also allow a customer to use his own encryption routine, which is not known or disclosed to the verification service provider or general public. This is a presently less favored embodiment because it makes the verification by decryption service less transparent to independent interested parties.

In specific embodiments, on a periodic basis, the service provider distributes a new edition or volume of UaEM (e.g., the JPED) and distributes it to numerous public libraries and other institutions, thereby making it a public archive. Any person can go a city library or other institution that acts as a repository and flip through a volume of JPED or view the JPED electronic version and see page after page of unintelligible gibberish. That person can go to a different city library or repository, access the same volume or edition of the JPED, and find exactly identical pages of gibberish. Although no one other than an authorized possessor of the decryption key can extract useful information from the encrypted document, the encrypted pages in their exact form are now a matter of permanent public record. There is no practical way for anyone to tamper with, destroy or deny the existence of this public record, because identical copies of the UaEM are held in numerous locations (some of which may be secure locations not disclosed to the public). The encryption/decryption algorithm is publicly known, so one cannot make the argument that a decrypted document does not actually correspond to what's published in a UaEM.

According to specific embodiments of the invention, a UaEM (e.g., the JPED) as herein described provides one or more of the following practical advantages or any combination thereof: 1) it is cheap; 2) it entails no risk actually disclosing the encrypted content; 3) it provides evidence that cannot reasonably be challenged; and 4) if there is litigation or threat of litigation, the UaEM verification process is fast and inexpensive.

As described above, there is no practical way for anyone to tamper with, destroy or deny the existence of the UaEM public record, because identical copies of UaEM are held in numerous disclosed and potentially undisclosed locations. According to specific embodiments of the invention, some form of inerasable physical record is used for at least some of the copies of the UaEM to provide a tangible record. In principle such “hard copy” need not take the form of a bound journal. From the standpoint of cost and storage capacity, storage on DVD-ROM or other low-cost, high-density media are one alternative. However, from the standpoint of initial public acceptance, printed pages in a bound journal format may be better than digital storage because of psychological factors such as physical tangibility, academic formality, and the longstanding tradition of paper record archives.

As the invention grows in popularity, its monthly output will eventually exceed the storage capacity of a printed archive. For example, a bound archive containing 1000 pages of text (500 paper pages double-sided) printed at 2400 dpi would likely have a maximum capacity of 100,000 characters per page and 100 million characters per volume. Although the number of characters per file submitted by customers will vary widely, it's likely that a printed monthly volume could accommodate a few hundred submissions before becoming impractically large. This is enough storage capacity to make a printed journal format feasible during the growth stages of a verification service using a system or method of the invention. Eventually, it would likely be necessary to phase in a non-paper medium such as DVD storage, but by then public acceptance of, and dependence on, a verification service using a system or method of the invention would be firmly established. One non-paper archive could be the metal die used to press DVD-ROMs for mass production (In the manufacture of CDs and DVDs, multiple identical electroformed nickel dies are made from a single glass master fabricated by photolithography. These metal dies are used to stamp polycarbonate blanks in mass production.). The “hard copy” in this case would be understood by the public to be analogous to an engraving plate kept in a vault at the U.S. mint. Much like a bound journal, it could be distributed to public libraries and made available for public viewing for those who desire the tangibility of something like a metal engraving plate. However, according to specific embodiments of the invention, the invention can be launched using a bound journal format to promote public acceptance, because the physical security of such a medium is tangible and easily understood.

A further advantage to high density encrypted UaEM is that it can more easily accommodate non-text media, including audio or video, and can more easily accommodate very large disclosures, such as large automated data sets generated by institutions performing drug discovery or genetic or protein or other large data set analysis.

In some embodiments or implementations, a UaEM can be understood as a single document submitted by a single author that is then stored and/or made available as described herein. In presently preferred embodiments, however, a UaEM is generally a practically inseparable collection of two or more different documents, encrypted with different keys, and joined together by physical or electronic means. While any individual encrypted document may be accessed and decrypted when authorized, in practice the entire UaEM is archived, dated, and distributed as a whole until such time as verification of an individual document is required. For tangible media, joining documents is accomplished by placing two or more documents in a particular volume of the tangible media (e.g., a printed volume or a DVD). For electronic versions of the UaEM, joining can be accomplished by including multiple documents into a single file (e.g., one PDF document) and using any known technique to ensure integrity of the single file, such as including a hash-value signature, or any other known means. In a further embodiment, all the encrypted files in a UaEM volume are encrypted together (for example, by the verification service provider) to produce a single encrypted data stream. In one example embodiment, neither the contents nor the data structure (e.g., start and end points) of the encrypted documents can be accessed without the volume decryption key from the verification service provided, though the characters in the UaEM can still be read and confirmed between multiple copies of the UaEM. Once the volume encryption key is applied, individual encrypted documents can be detected, but the content of those documents is still gibberish and encrypted without the individual document decryption key.

While actually distributing electronic and/or tangible volumes of a UaEM is preferable for a number of reasons indicated herein, in an alternative embodiment, the invention can operate with a single trusted repository or archive including an archive of electronic versions of UaEM volumes available on the Internet. In such an embodiment, the UaEM is “distributable” and is “virtually distributed” to the extent that any interested party can download and store the file for any desired period of time. including permanently. The optional assemblies of multiple encrypted documents into a single UaEM volume even in this embodiment will have the further advantage of making it more likely that any given encrypted document would in fact have been downloaded and stored and thus make the “virtual distribution” of the UaEM through making it publicly available more of a deterrent to any attempted fraud and more of an assurance that any later verification is genuine. The knowledge that the archive can be and could have been accessed at any time and any UaEM volume (or, optionally, any individual encrypted document) contained therein could have been downloaded and stored and/or downloaded and identified with a hash value or similar hard to forge identification, may be enough to convince interested parties in the validity of the priority claim. In such a case, the verification service provider can in addition maintain and make publicly available a physical record to verify the authenticity of an electronic record that does not depend in any way on the integrity of the stored encrypted electronic data. In other words, because of the availability of the encrypted document from different sources, or from a trusted source, there is no question that the decrypted document is a genuine, unaltered copy of a document available on the asserted creation date. Alternatively, in this or any embodiment, a copy of an archive may be kept at undisclosed locations as a back up against tampering with publicly available copies. Distribution by electronic means can also be used to supplement a more limited distribution of a tangible UaEM.

Thus, in general terms, the invention can be understood as providing a verification system and method that generally includes: encryption of a document by an owner or author or trusted third party; disclosing the encrypted document to one or more interested parties or to the general public; verifying a creation date of an entire document by decrypting the encrypted document to prove the existence of the original document and possession of the ideas contained therein at least as early as the time of availability of the UaEM.

In further embodiments, the invention can be understood as providing a verification system and method that further includes: using an un-interested or trusted archive and verification service provider to receive encrypted documents, archive them, distribute them in a UaEM, and provide ancillary services such as providing assistance or expert witnesses should verification by questioned, provides an easy to use encryption algorithm, and handles the disclosure on behalf of multiple authors.

Various embodiments of the present invention provide methods and/or systems that may include exchanging documents and information over a communications network. According to specific embodiments of the invention, a client system is provided with a set of interfaces that allow a user to perform the functions described herein and/or allows a client system to perform one or more of the functions described periodically and automatically according to a user configuration. The client system displays information regarding instructions for encrypting and uploading a document, optionally instructions for decrypting a document, payment instructions, etc., and displays an indication of an action that a user is to perform to request a service (such as a button or text field). In response to a user input, the client system sends to a server system the necessary information to access the service. The server system accepts encrypted documents and performs other operations as described herein. According to specific embodiments of the present invention, a client system is, or has previously been, provided with an executable code file that allows the client system to perform the operations described herein.

In specific embodiments, a client system comprises an Encrypted Verification Device™ which, according to specific embodiments of the invention, is an encryption device that includes an interface for receiving an unencrypted electronic document (such as a logic module, USB socket, Ethernet socket, wireless receiver, etc.), encrypting the document using a machine generated or user-supplied key, and outputting an encrypted document for transmission to a verification service provider. Such a verification device may have a number of additional features to facilitate ease of use, for example but not limited to: automatically and periodically collecting one or more indicated documents and automatically and periodically transmitting an encrypted document to a service provider; automatically generating one or more encryption keys and optionally storing or transmitting said keys for storage to a trusted location; automatically time-stamping one or more entries, etc. An Encrypted Verification Device™ according to specific embodiments of the invention may communicate securely with one or more external systems, such as a verification service provider system, in performing one or more of its functions.

In specific embodiments, an Encrypted Verification Device™ may be a stand alone device or system. In other embodiments, an Encrypted Verification Device™ may incorporated into other related devices, such an electronic notebook, electronic lab notebook, personal digital assistant (PDA), laboratory workstation, including workstations that automatically collect or generate data to be included in a UaEM, or other computing device.

Thus, in further embodiments, the present invention may be understood in the context of enabling public encrypted disclosure using a communication channel. An important application for the present invention, and an independent embodiment, is in the field of providing the service of public encrypted disclosure over the Internet, optionally using Internet media protocols and formats, such as JSP, ASPX, HTTP, RTTP, XML, HTML, dHTML, VRML, as well as image, audio, or video formats, etc. However, using the teachings provided herein, it will be understood by those of skill in the art that the methods and apparatus of the present invention could be advantageously used in other related situations where users access content over a communication channel, such as modem access systems, institution network systems, wireless systems, etc.

### Software Implementations

Various embodiments of the present invention provide methods and/or systems that include steps or elements for document handling that can be implemented on a general purpose or special purpose information handling appliance using a suitable programming language such as Java, C++, Cobol, C, Pascal, Fortran., PL1, LISP, assembly, etc., and any suitable data or formatting specifications, such as HTML, XML, dHTML, TIFF, JPEG, tab-delimited text, binary, etc. In the interest of clarity, not all features of an actual implementation are described in this specification. It will be understood that in the development of any such actual implementation (as in any software development project), numerous implementation-specific decisions must be made to achieve the developers' specific goals and subgoals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

### Other Features & Benefits

The invention and various specific aspects and embodiments will be better understood with reference to the following drawings and detailed descriptions. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims and equivalents.

Furthermore, it is well known in the art that systems and methods such as described herein can include a variety of different components and different functions in a modular fashion. Different embodiments of the invention can include different mixtures of elements and functions and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative embodiment in this specification. Given the modular nature of the systems and methods of the invention, specific embodiments of the invention include all practical combinations the elements described herein to used to provide a verification by encrypted disclosure service as herein described.

In some of the drawings and detailed descriptions below, the present invention is described in terms of the important independent embodiment of a system operating on a digital data network. This should not be taken to limit the invention, which, using the teachings provided herein, can be applied to other situations, such as cable television networks, wireless networks, etc. Furthermore, in some aspects, the present invention is described in terms of client/server systems. A number of computing systems and computing architectures are described in the art as client/server art. For the purposes of this description, client/server should be understood to include any architecture or configuration wherein an element acting as a client accesses a remote and/or separate program or device that is providing the desired service (e.g., a server).

All references, publications, patents, and patent applications cited herein are hereby incorporated by reference in their entirety for all purposes.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a diagram illustrating an overview of a system and operation according to specific embodiments.

FIG. 2 is a diagram illustrating pages of a distributed encrypted journal according to specific embodiments.

FIG. 3A-C illustrate a graphical user interface for submitting an encrypted document according to specific embodiments.

FIG. 4A-C illustrate example graphical user interfaces for accessing encrypted document containing text, audio, or video using a verification viewer according to specific embodiments.

FIG. 5A-D illustrate flows chart depicting steps of example methods according to specific embodiments of the invention.

FIG. 6 is a block diagram showing further details of functional components of a server system according to specific embodiments of the invention.

FIG. 7A-B are block diagrams showing representative example logic devices in which various aspects of the present invention may be embodied.

FIG. 8 illustrates an example graphical user interface for a user learning about and logging on to a website according to specific embodiments.

### DETAILED DESCRIPTION OF SPECIFIC EMBODIMENTS

Before describing the present invention in detail, it is to be understood that this invention is not limited to particular compositions or systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content and context clearly dictates otherwise. Thus, for example, reference to “a device” includes a combination of two or more such devices, and the like.

Unless defined otherwise, technical and scientific terms used herein have meanings as commonly understood by one of ordinary skill in the art to which the invention pertains. Although any methods and materials similar or equivalent to those described herein can be used in practice or for testing of the present invention, the preferred materials and methods are described herein.

In the following description, for the purposes of explanation, specific details are set forth in order to provide a thorough understanding of the invention. However, it will be apparent that the invention may be practiced without these specific details. In other instances, well-known structures and devices are depicted in block diagram form in order to avoid unnecessarily obscuring the invention.

### 1. Functional Overview

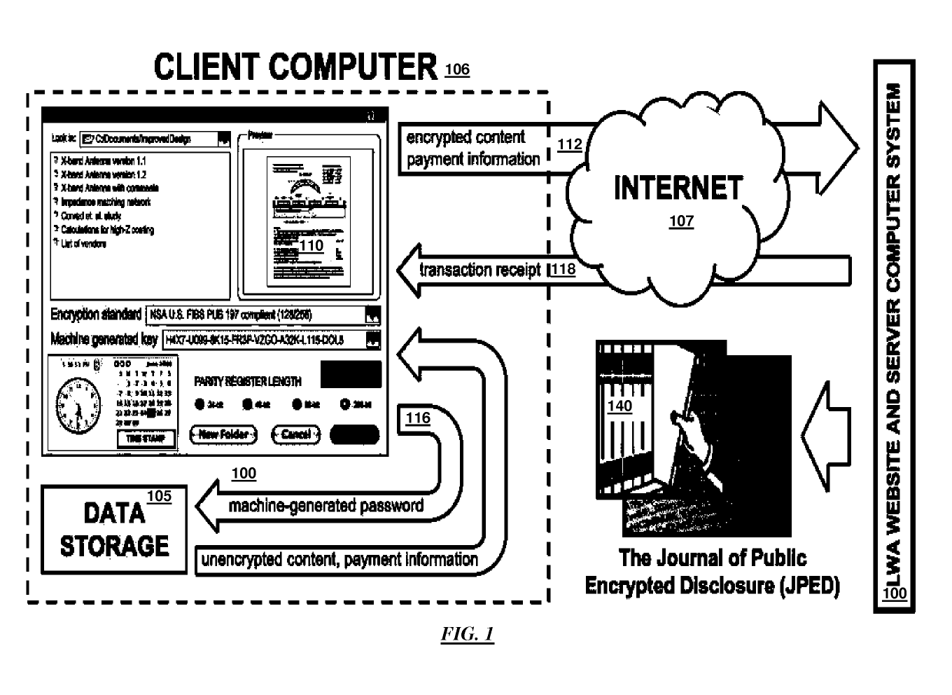

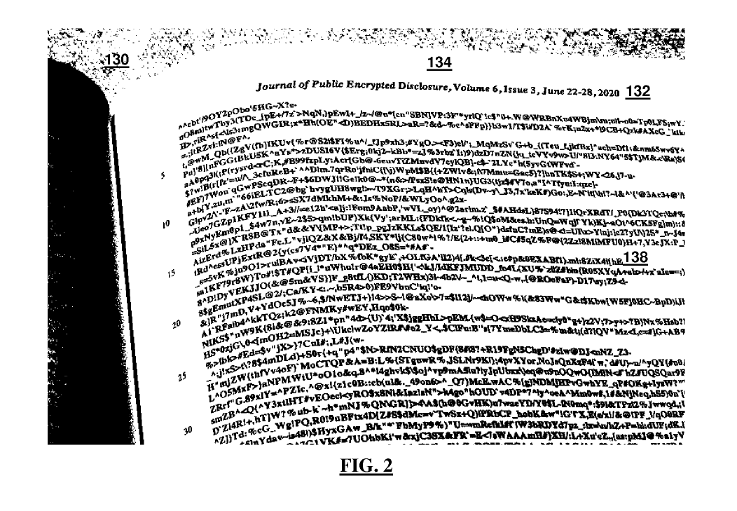

FIG. 1 is a diagram illustrating an overview of a system and operation according to specific embodiments. A general example embodiment of the invention is described, including some optional elements.

The figure illustrates a server system 100, that is contacted by users using client information devices such as 106 over a communication channel or network 107. These users download instructions for encrypting an original document 110 to produce an encrypted document 112. The instructions may comprise downloadable executable code and/or user directions for performing an encryption using a variety of available encryption technologies. Encryption takes place at the client's computer system and in addition to an encrypted document generally produces a decryption key 116. Device 106 uploads the encrypted document to server 100 and is provided with directions for storage of the decryption key. The key may alternatively be provided in a small certificate file that may be stored on the client system for example in data storage 105. The user also receives confirmation data from the server, including a receipt file and identification data 118 allowing the user to at a later time identify the uploaded encrypted file in an encrypted media as described below.

Once the server system 100 receives encrypted document 112, the system can optionally record and attach an upload or receipt date for the document. Server system 100 additionally stores each received encrypted document with a receipt date in an archive storage system.

From time to time, as further described herein, server system 100 collects one or more encrypted documents 112 into a journal media 130. Journal media 130 is typically a tangible, effectively unalterable media, such as a bound paper journal, DVD, CD, or read-only memory (ROM). A sufficient number of distributable copies of the journal media are made and distributed to a plurality of repositories 140. In alternative embodiments, journal media 130 and its copies may be an electronic file that includes internal and external content verification, one or more means to enable public viewing of the encrypted archive, and that is distributed using a communication channel for electronic or magnetic storage to a large number of repositories.

Once at the distributed repositories 140, the encrypted document is available to anyone who possesses the necessary decryption key and potentially other verifications, such as a second decryption key received from a server system authority after verification that the data may be released.

### 2. Example Encrypted Journal

FIG. 2 is a diagram illustrating pages of a distributed encrypted journal according to specific embodiments. As described elsewhere herein, according to specific embodiments of the invention, a system of the invention transforms a human readable or understandable media to an encrypted medium that can none the less be printed on a page (e.g., in text form) or included in an electronic file that can be examined, such as a byte file. As shown in the figure, a journal 130 can include a journal publication date 132, a journal identifier 134, and encrypted document contents 138.

### 3. Example Author User Interface

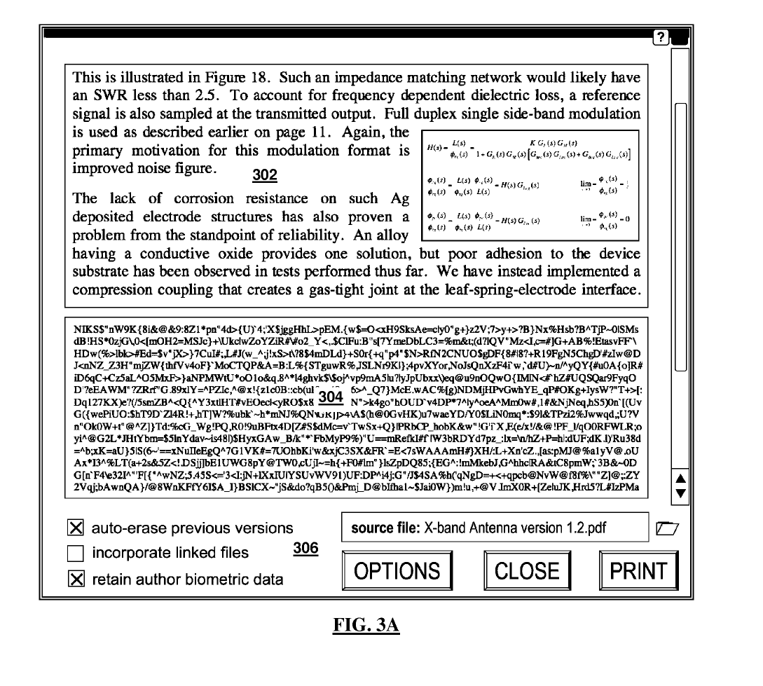

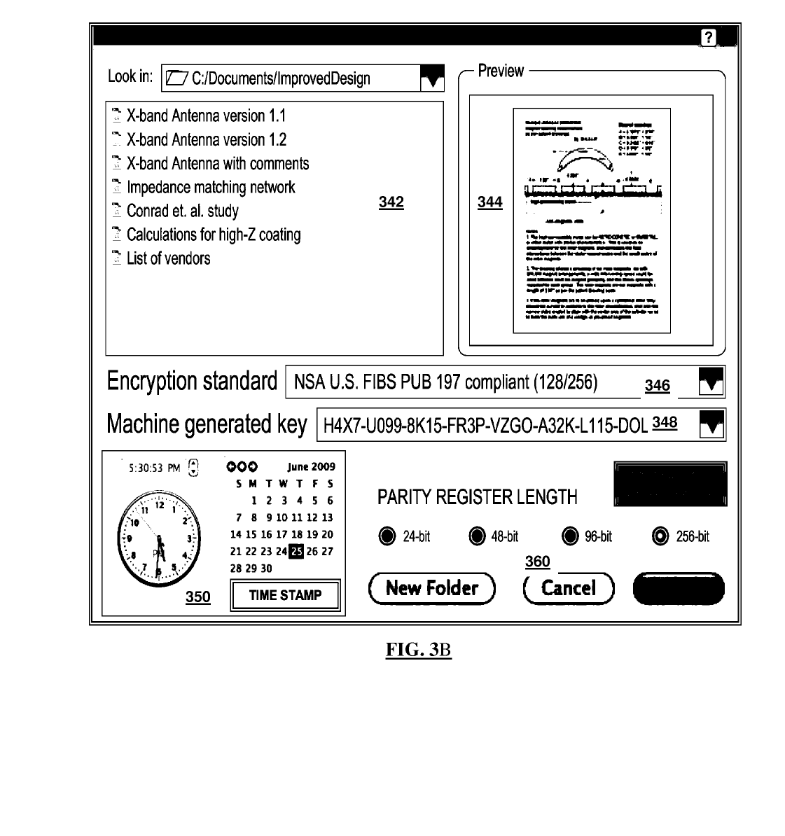

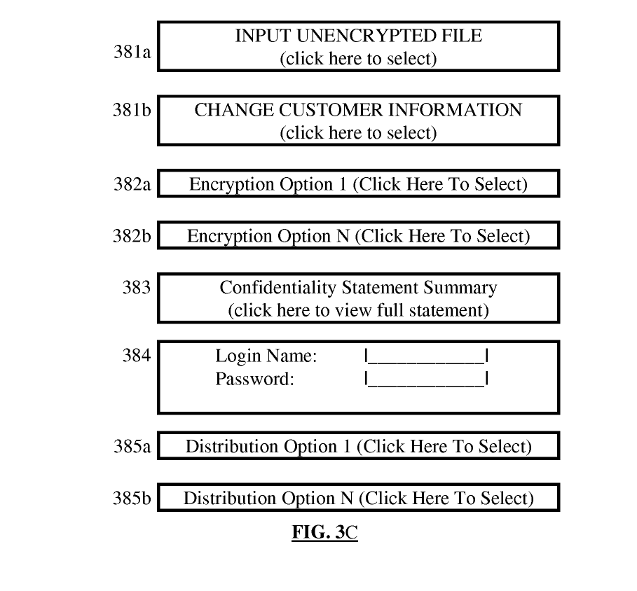

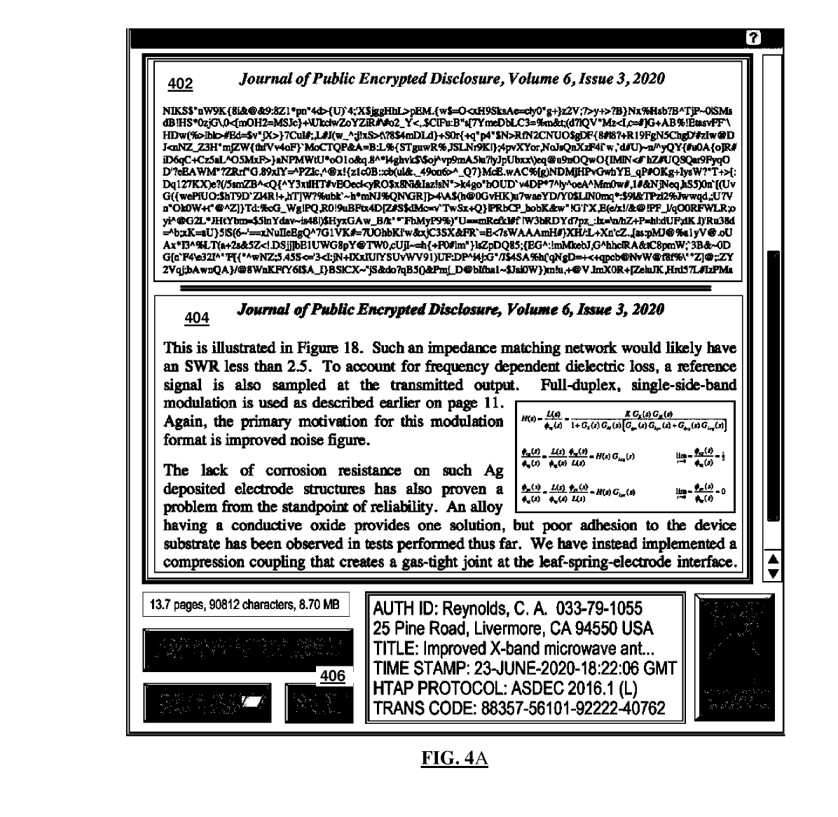

FIG. 3A-C illustrate a graphical user interface for submitting an encrypted document according to specific embodiments. An example user interface as shown in FIG. 3A provides a window view of an unencrypted document 302 and a window showing the document after encryption an unencrypted document 304. Activation buttons or check boxes 306 allow a user to encrypt and submit a document as described herein and provide for further actions as will be understood in the art. An options button, for example, may allow a user to select one or more options related to the service. In the example illustrated, a check box labeled “auto-erase previous versions” allows a user to indicate that earlier versions of an encrypted document from a modified original document should be erased; a check box labeled “retain author biometric data” allows a user to indicate that a customer's biometric data from a previous submission should be associated with a current submission.

Alternatively, a user may submit an encrypted document via email or any other convenient data transmission means, or by physical delivery of one or more media containing said encrypted document. Alternatively, a document may be submitted automatically and/or periodically without user instructions as described herein.

Multiple techniques for providing various user interfaces with multiple input fields or selection indications such as shown in FIG. 3A are well known in the art. In specific implementations and/or embodiments, this example user interface may be sent from the server system to the client system when a user accessed the server system. Alternatively, this example user interface may be enabled by logic instructions or modules that reside at the client system. As will be understood in the art, one or more selection buttons or check boxes or regions can activate a set of further interface screens that allows a user to select from different available options. One skilled in the art would appreciate that these various sections can be omitted or rearranged or adapted in various ways and that one or more activation buttons or options can be provided on user interface screens to enable any of the functional elements described herein, including in the attached claims.

An example user interface as shown in FIG. 3B illustrates a window area 342 for selecting a document, a window area 344 for previewing a document, a window 346 for displaying and optionally selecting an encryption standard, a window 348 for displaying and optionally selecting an decryption key, a time-stamp indicator 350 showing a time that will be used to time stamp the document at encryption and alternatively allowing a user to include a claimed creation date time-stamp for a document. Activation buttons or check boxes 360 allow a user to indicate file checking such as a parity register length and perform other functions related to encryption.

Alternatively, a user may submit an encrypted document via email or any other convenient data transmission means, or by physical delivery of one or more media containing said encrypted document. Alternatively, a document may be submitted automatically and/or periodically without user instructions, such as by automated drug discovery, protein analysis, or genetic analysis systems.

Multiple techniques for providing various user interfaces with multiple input fields or selection indications such as shown in FIG. 3A are well known in the art. In specific implementations and/or embodiments, this example user interface may be sent from the server system to the client system when a user accessed the server system. Alternatively, this example user interface may be enabled by logic instructions or modules that reside at the client system. As will be understood in the art, one or more selection buttons or check boxes or regions can activate a set of further interface screens that allows a user to select from different available options. One skilled in the art would appreciate that these various sections can be omitted or rearranged or adapted in various ways and that one or more activation buttons or options can be provided on user interface screens to enable any of the functional elements described herein, including in the attached claims.

FIG. 3C illustrates an example general simplified graphical interface a verification service client system according to specific embodiments of the invention. This illustrated example interface includes an indication 381a, allowing a user to select a document for encryption, an indication 381a, allowing a user to change customer information, indications 382a and 382b, allowing a user to select one or more encryption options as described herein, an indication 383, allowing a user to view instructions or confidentiality statements; an area 384 allowing a user to input identifying information: indications 385a and 385b, allowing a user to select one or more distribution options as described herein.

### 4. Example Decryption User Interface

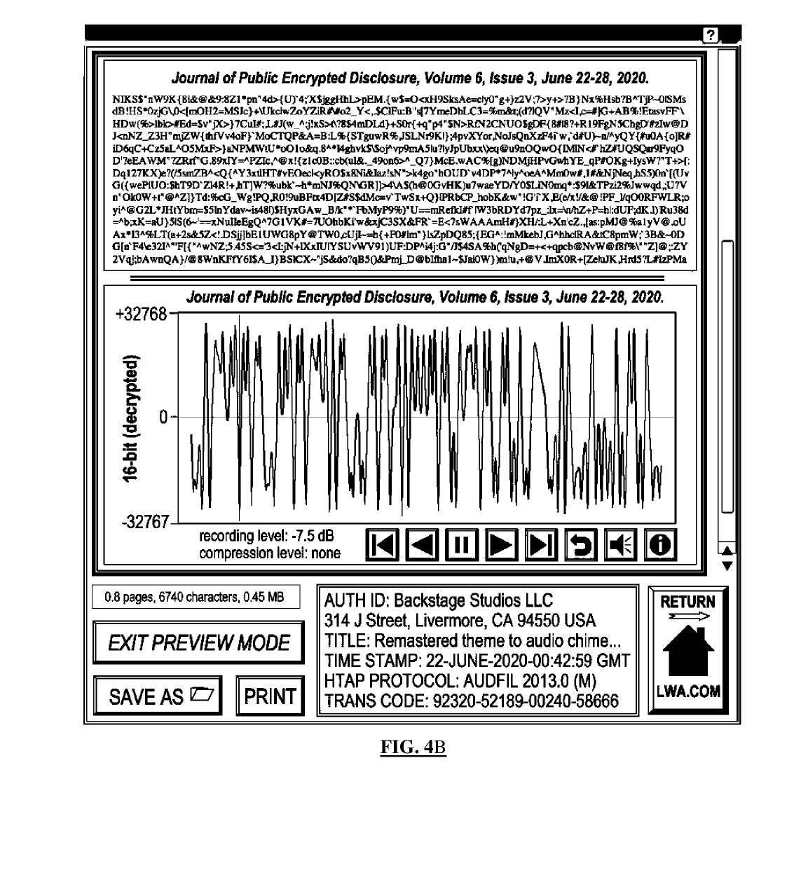

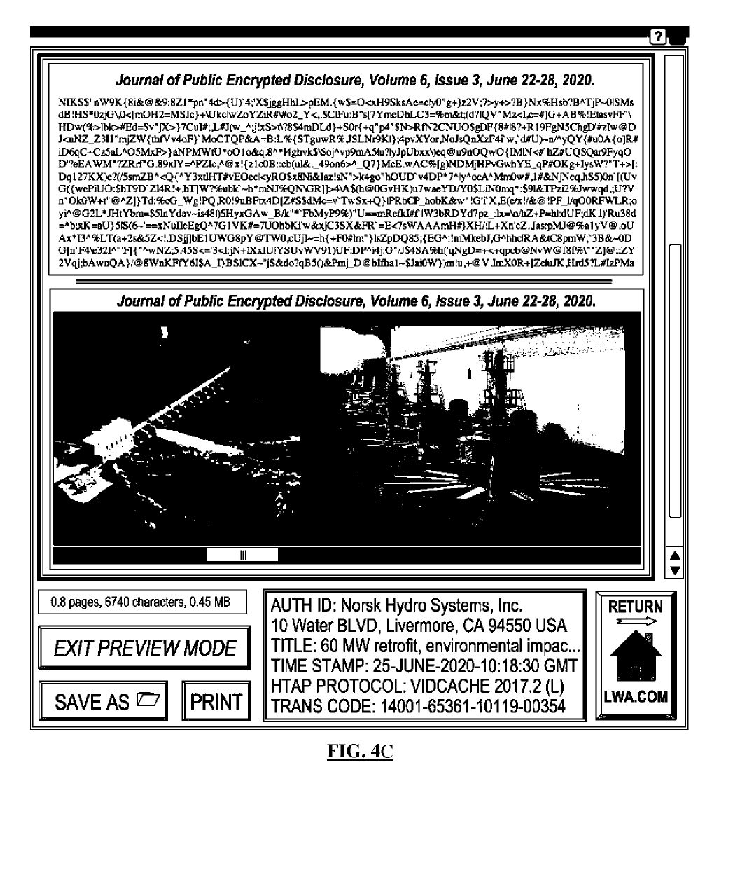

FIG. 4A-C illustrate example graphical user interfaces for accessing encrypted document containing text, audio, or video using a verification viewer according to specific embodiments As can be seen in the examples, a user having supplied the correct decryption key, can view and or hear a document exactly as it existed on the date it was encrypted and submitted. An example user interface as shown provides a window view of an encrypted document 402 and a window showing the document after decryption 404. Activation buttons or check boxes 406 allow a user to select various functions related to decryption. As shown in the figure, in this example the encrypted document includes an unencrypted identification of the volume and date of a UaEM journal according to specific embodiments of the invention. In specific embodiments, a decryption algorithm recognizes the unencrypted portions so as not to interfere with decryption. FIGS. 4B-C illustrate analogous interfaces showing audio and video data.

As will be further understood from the teachings provided herein, the present invention encompasses a variety of specific embodiments for performing these steps. As further described below, the request for a verification by encryption may be received in a variety of ways, including through one or more graphical user interfaces provided by the to server system to the client system or by the server system receiving an email or other digital message or communication from the client system. Thus, according to specific embodiments of the present invention, data and/or indications can be transmitted to the server using any method for transmitting digital data, including HTML communications, FTP communications, email communications, wireless communications, etc. In various embodiments, indications of desired data can be received from a human user selecting from a graphical interface at a computing device.

After the request is received, a server system according to specific embodiments of the present invention accesses the requested data. As discussed further below, a server system may hold data files prior to receiving a request for particular data or the server system can create requested data while responding to a request from a user to receive the sequence data. When the data is available at the server system, the server system transmits the data to a client system (Step 1). At the client system, a logic routine may be used to access the file that is transmitted (Step 2).

### 5. Example Flow Diagram

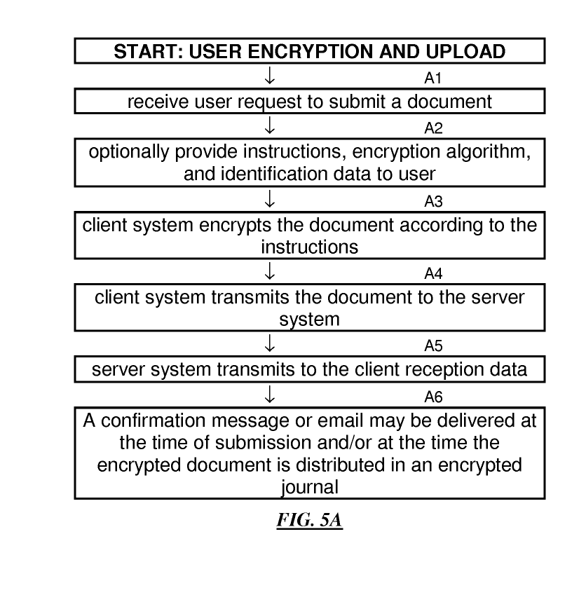

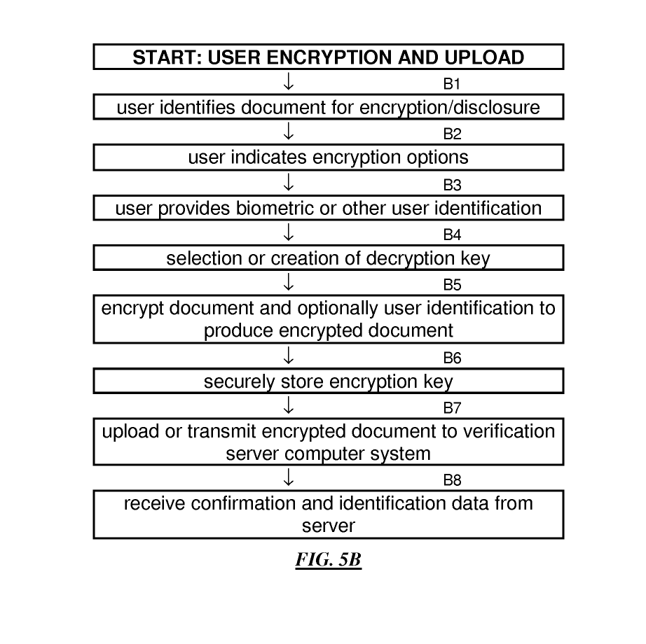

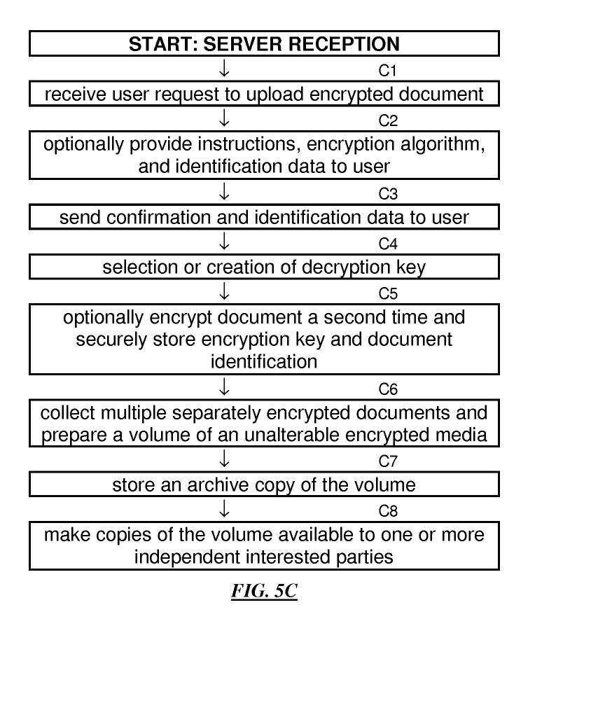

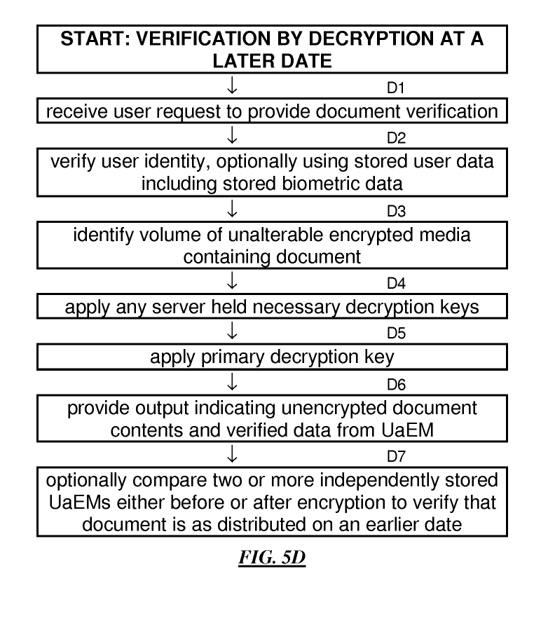

FIG. 5A-D illustrate flows chart depicting steps of example methods according to specific embodiments of the invention. According to the embodiment illustrated, the method includes a client communicating with a server that the client desires to submit a document for priority verification (Step A1). The server provides one or more web-pages or other information to the client regarding making a submission, including encryption instructions. (Step A2). The client system encrypts the document according to the instructions (Step A3). The client system, also, with or without specific additional user input, transmits the document to the server system (Step A4). The server system then transmits to the client reception data (Step A5) optionally including data regarding how to identify the encrypted document and when the document will be included in an encrypted journal. A confirmation message or email may be delivered at the time of submission and/or at the time the encrypted document is distributed in an encrypted journal (Step A6).

Additional information transmitted between the client and server system can include a server generated a Web page describing any available service options. Transmitted information may also include the customer's name and indications of a payment account.

### 6. Example Detailed System Embodiment

FIG. 6 is a block diagram showing further details of functional components of a server system according to specific embodiments of the invention.

The figure shows a server system 600, providing an author/user interface 602 and that is contacted using client system information devices such as 606 over a communication channel or network. These users download instructions 608 for encrypting an original document 610 to produce an encrypted document 612. Instructions 608 may comprise downloadable executable code and/or user directions for performing an encryption using a variety of available encryption technologies. Encryption takes place at the client's computer system and in addition to encrypted document 612, generally produces a decryption key 616. Client system 606 may also receive and transmit one or more items of user identification data 617, such as biometric data (fingerprints, photo ID, etc.) or other personal data, such as a password or social security number. The user uses device 606 to upload the encrypted document to server 600 and is provided with directions for storage of the decryption key. The key may alternatively be provided in a small certificate file that may be stored on the client system for example in data storage at client system 606. The user also receives confirmation data from the server, including a receipt file and identification data 618 allowing the user to at a later time identify the uploaded encrypted file in an encrypted journal as described below.

Once the server system 600 receives encrypted document 612, the system can optionally record and attach an upload or receipt date 620 for the document. Server system 600 additionally stores each received encrypted document with a receipt date in archive storage system 622.

From time to time, as further described herein, server system 600 collects one or more encrypted documents 612 into a journal media 630. Journal media 630 is typically a tangible, effectively unalterable media, such as a bound paper journal, DVD, CD, or read-only memory (ROM). A sufficient number of distributable copies 632 of the journal media are made and distributed to a plurality of repositories 640. In alternative embodiments, journal media 630 and its copies may be an electronic file that includes internal and external content verification, one or more means to enable public viewing of the encrypted archive, and that is distributed using a communication channel for electronic or magnetic storage to a large number of repositories 660.

Once at the distributed repositories, 640, the encrypted document is available to anyone who possesses the necessary decryption key and potentially other verifications, such as a second decryption key received from a server system authority after verification that the data may be released.

One skilled in the art would appreciate from the teachings herein that transmission of the electronic data as described herein can be used in various environments other than via a graphical interface over the Internet. For example, data can be in an electronic mail environment in which a request is submitted in an electronic mail message. In addition, various other communication channels may be used such as local area network, wide area network, wireless communications, or point-to-point dial up connection. A server system may comprise any combination of hardware or software that can process the functions described herein. A client system device may comprise any combination of hardware or software that can interact with the server system as described herein.

### 7. Embodiment in a Programmed Information Appliance

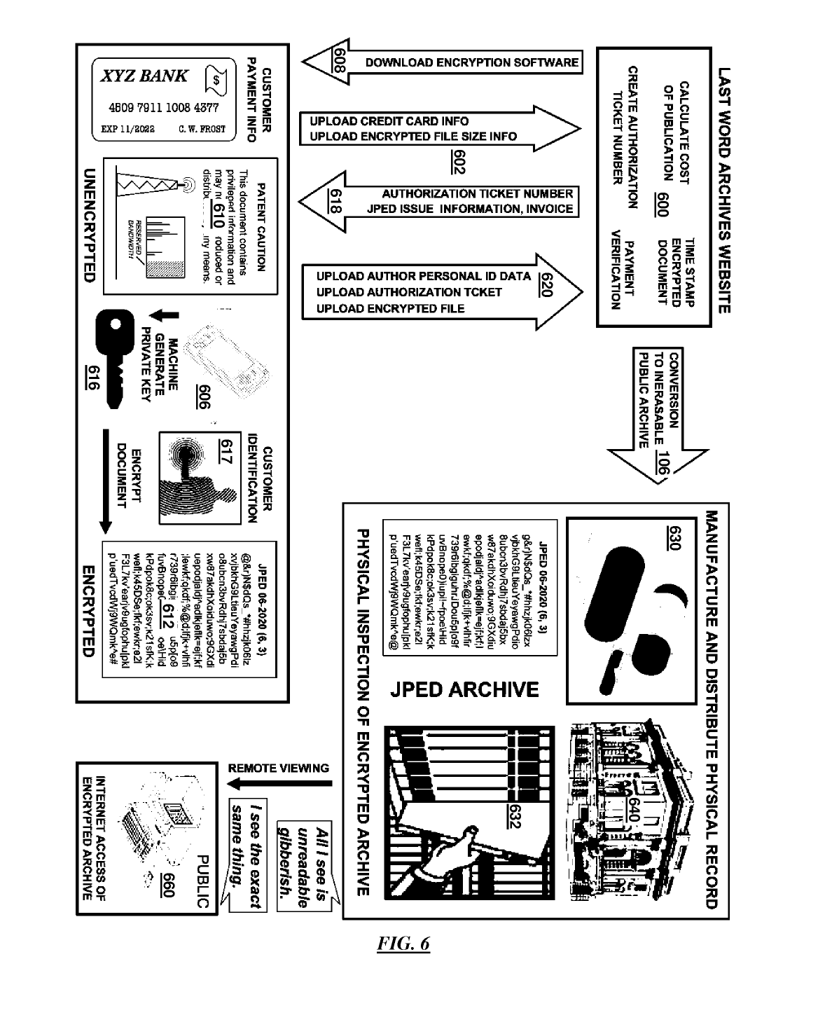

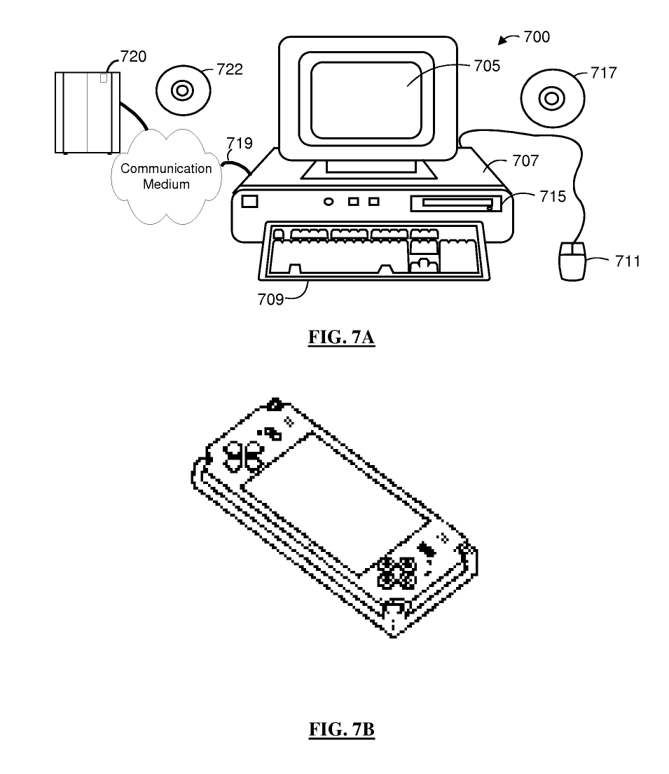

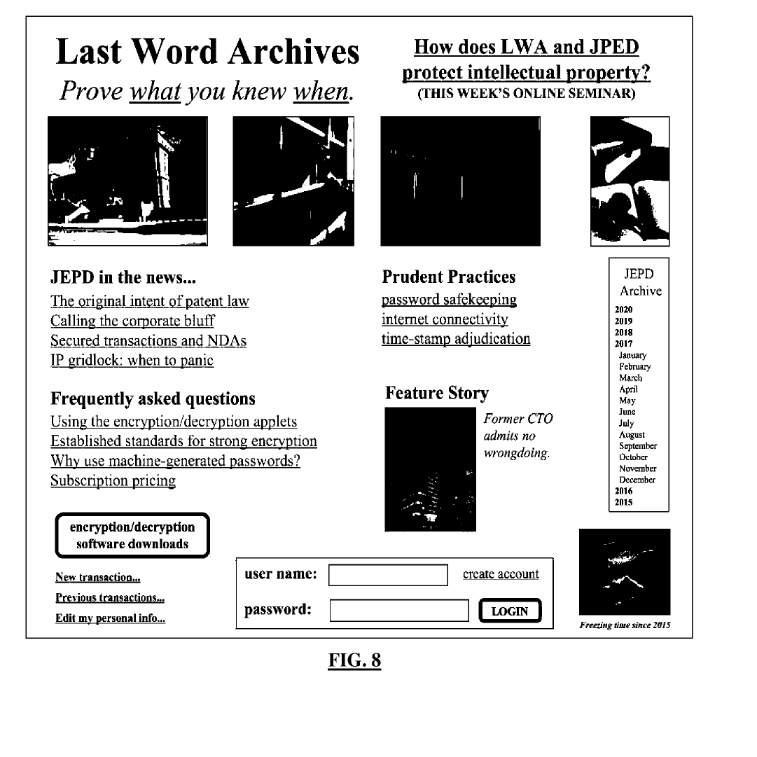

FIG. 7A-B are block diagrams showing representative example logic devices in which various aspects of the present invention may be embodied. As will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a user on a fixed media for physically loading into a user's computer or a fixed media containing logic instructions may reside on a remote server that a user accesses through a communication medium in order to download a program component.

FIG. 7A shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of the invention. One type of logical apparatus that may embody the invention is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc. In specific embodiments, the invention may be embodied in whole or in part as software recorded on this fixed media. Communication port 719 may also be used to initially receive instructions that are used to program such a system and may represent any type of communication connection.

FIG. 7B shows the form of an alternative an information appliance (or digital device) in the form of a hand-held. Such a device is described above, one implementation of which is referred to as the Encrypted Verification Device™. As will be understood in the art, such a device includes within it one or more of a communications port, a CPU or processor, optional mechanisms, displays, and electronic or magnetic memory. Such a device can include other functions, such as personal digital assistant functions, electronic notebook functions, or cellular telephone functions, as will be well understood in the art.

The invention also may be embodied in whole or in part within the circuitry of an application specific integrated circuit (ASIC) or a programmable logic device (PLD) that can be used in building an Encryption Verification Device or other information system as described herein. In such a case, the invention may be embodied in a computer understandable descriptor language, which may be used to create an ASIC, or PLD that operates as herein described.

### 8. Other Features and Alternative Embodiments

While a presently preferred embodiment has been described above, a number of options, modifications, additions, or deletions of features may be included in implementations according to specific embodiments of the invention. The description of specific options below does not preclude other options that will be understood by those of skill in the art.

According to specific embodiments of the invention, the encryption/decryption algorithm is publicly known and generally meets standards for “strong” encryption such that the quality of the encryption/decryption algorithm makes it impossible, in any reasonable length of time, to decode the encrypted content without the key. Numerous encryption algorithms have been developed and are known that have this property.

In general, the verification service provider (e.g., a private company) has no ability to access to the content in its decrypted form and this is publicly known. This eliminates all potential concerns about the service provider's ability to maintain absolute confidentiality. This also eliminates the possibility of liability in case of other disclosure of the contents of the encrypted document.

In specific embodiments, a physical media is used and publicized to underscore that that the service relies in no way on the integrity of electronic data.

In further embodiments, a stolen private key is insufficient for decryption because the verification service provider performs a second encryption on the received encrypted document using a key held by the service provided. In these embodiments, this second key is only made available after a user is positively identified by the service provider, for example, by showing up in person, at which point the service provider furnishes its portion of the key.

In further embodiments, a number of strategies may be used to reduce the impact of a lost key. In one such embodiment, the service provider may receive a large value check sum of the original file, which is prepared by the client computer prior to completing the encryption. This check sum may be disclosed along with the encrypted document so that should a key be lost, the check sum will provide some authentication of the original document. In an alternative embodiment, the client side encryption algorithm may be one that includes the feature of being able to confirm that an encrypted document was derived from an available unencrypted document. In this way, should the key be lost, the original document can still be confirmed as existing on the date that the encrypted document was created. Any other services for recovery of lost key information. may be employed, though some of these services may inherently reduce the security of the encryption. However, alternatively, it may be desirable for a service provider to ensure and demonstrate that if private key information is lost, there is no possible method of decryption.

The encryption key can be possessed by one party or more than one party. The key may also be distributed so that no single party has all portions of the key. Finally, some parties may optionally elect to have the service provider or some other trusted entity to have access to all or portions of the private key.

Encryption according to specific embodiments of the invention can be done entirely by a publicly known and specified algorithm, where either a user decides the length and/or form of the encryption key or must use a decryption key that adheres to one or more minimum security standards or where the decryption key, or portions of it, are machine-generated (or non-machine-generated, possibly at the option of the user). Alternatively, a user may use his own encryption algorithm, either instead of a service provider indicated algorithm or in addition to it. In various embodiments, it may be desired to require more than one password and/or party to run the decryption algorithm.

In specific embodiments, a server computer system as described herein will be associated with a verification service provider that provides one or more services related to document creation date verification. On such provider is referred to herein as Last Word Archives™. According to specific embodiments of the invention, such an entity may provide a “full service” creation date verification service by, when requested by a user, certifying the findings from the decrypted file or providing an expert for court proceedings who can demonstrate the decryption process and handle all potential questions about its validity, or provide a master tangible record of the UaEM when desired to prove that the encrypted document has not been altered. Such an entity may also provide authorization services to provide a decryption key for a UaEM, to replace a lost key when such a service is available or desired, or to provide a secondary decryption key for a UaEM where encryption documents are secondarily encrypted at a server computer system.

In further embodiments, prize money and/or other considerations may be publicly offered to anyone who can demonstrate that the security of the encryption scheme can be breached.

In further embodiments, one or more verification data items may be included in the UaEM for one or more encrypted documents. Such verification data can be data that would be easily available to the authorized owner (such as a social security number or finger print or other biometric data) but that would be difficult to produce for a fraudulent access. Such data may be unencrypted, encrypted with a separate key, or encrypted with the same private key. In one embodiment, such data is used by an authorizing entity before providing final access to a secondary decryption key and therefore to the document.

According to specific embodiments of the invention, such data can be encrypted using the same private key used to encrypt the document before it is uploaded to the server. In this case, neither the verification service provider nor the public will have access to the identity data without the private key. Once the private key is submitted to the encryption authority, it can verify the identity data (such as a finger print image or social security number or facial photograph) before releasing the secondary decryption key.

In embodiments in which the published user content contains information about the identity of the author(s) or owners of the document, in either encrypted form, unencrypted form, or both possession of the private key can be necessary but not sufficient to decrypt content published in JPED. In addition to having possession of the private key, the person in question would have to pass a positive identification process, conducted in person and/or by automated means, in which identification information such as birth certificate, social security number, photo ID, finger prints, or more advanced biometric data is checked.

In alternative embodiments in which the published user content contains information about the identity of the author(s) or owners of the document, in either encrypted form, unencrypted form, or both, possession of a decryption key may not be necessary. In such an embodiment, the verification service provider holds the decryption key and a person wishing to decrypt the document must pass a similar positive identification process, conducted in person and/or by automated means, in which identification information such as birth certificate, social security number, photo ID, finger prints, or more advanced biometric data is checked. In such embodiments, the verification service provider may have received the document in unencrypted for and encrypted it before making the public disclosure.

In combination with any of the embodiments provided above, a verification service provider may offer a verification service as a subscription service (e.g., to a pharmaceutical company or other research institution doing drug discovery or data analysis) Such a service may include automatic encryption and transmission to the service provider, as described herein, or may be only when instituted by the user. Such a subscription service allows a user to document progress in research and development on a regular and continuous basis.

In various embodiments as described herein, a UaEM includes further features for proof of authenticity, for example a printed journal verification service may include a water mark, magnetic thread, microdots, microscopic serial numbers, etc. Similar physical or electronic data may be included in distributed optical or electronic media.

In some situations, it may be desired to use less strong encryption, or to allow a service provider some degree of access to unencrypted content (a “lost key recovery” option is one of several possible examples), or provide someone other than the client with some degree of access to unencrypted content. Various security features, such as one or more of the encryptions described herein, may be optional or partially implemented.

In some situations, it may be desirable for some or all of the encrypted content not to be made publicly available, but instead reside with a trusted party, such as the service provider. In such a situation, a user may optionally choose to have a file identifier (such as a check-sum) or either the encrypted document, the unencrypted document, or both, made publicly available to provide some verification of authenticity.

An optional amount of information, such as author, submission date, abstract etc., may be published or otherwise made available un-encrypted form according to specific embodiments of the invention.

As described herein, any encryption scheme can be used to provide any of the encryptions in various embodiments, including encryption keys with any number of bits (24, 36, 100, 128, 1000, or whatever), a key of any format can be used. One or multiple passwords may be used to access or enable any step or element of the invention. Any other additions, modifications, substitutions, or deletions of elements or steps that do not depart from the scope and spirit of the invention should be understood as encompassed by the attached claims.

It will be apparent from the discussion provided herein that many different applications for the invention are possible. These include, but are not limited to: dated proof of invention conception; dated proof of knowledge of a trade secret; dated proof of code or algorithm development, or other applications pertinent to copyright law; dated proof of content such as laboratory notebooks; applications such as non-disclosure agreements (in which two or more parties exchange information, and the subject invention is used to documented who contributed what information, and when that information was contributed); a service that provides the functionality of a notary public by certifying the existence and date of a document; dated proof of the existence of any legal document, such as a signed contract, that otherwise could later be fabricated or forged; such as any document or data concerning wills and estate planning; dated proof of financial transactions, or financial agreements (For example, a standing order with a broker to liquidate all of shares of XYZ Inc. if the stock drops below $60 a share, with an Incontrovertible Time-Stamp™, for example of Jan. 1, 2010. If XYZ Inc. stock value reduced substantially on Jul. 1, 2010, and there are accusations of insider trading in the days leading up to the collapse of the stock price, a user (possibly an executive of the company) can prove that a decision to sell the stock on Jun. 29, 2010 was not based on inside information); legal evidence of any form in which a time stamp has a bearing the validity of that evidence.

In specific embodiments, the invention may include a downloadable encryption applet or downloadable stand alone program that includes something analogous to a progress bar that shows a representation of the encryption process as a page of text and or graphics that progresses through a series of scrambling steps, such that the recognizable text/graphics gradually dissolves into gibberish. This is a visual feature that provides users with an intuitive sense of how thoroughly content submitted to the service provider is scrambled. The user sees an excerpt from a document that starts out clear and intelligible get converted into something that that appears to be completely random.

In further specific embodiments, the invention intentionally takes an intuitively easy to understand low-tech approach to circumvent one of the fundamental and intrinsic weaknesses of high tech approaches used in the prior art. For example, hash-functions, while mathematically provable to be difficult to forge, do not provide an intuitive assurance that the original document is genuine and unaltered. Even where a hash-function provides near mathematical certainty, this still would need to be justified and explained at length to a non-technical arbiter (such as a judge, jury, or the general public.) The “low-tech” methodology of Public Encrypted Disclosure™ in contrast, is easy to understand. When a non-technical arbiter is presented with an encrypted document that has been publicly available and is shown that that document can be decrypted to produce an unencrypted document, little or no further explanation is necessary to demonstrate that the unencrypted document could not have been modified. Thus, in specific embodiments, the invention provides a methodology for data archiving and time-stamping that can readily be understood to be infallible by members of the general public or an individual without a technical background. In particular, where a known, publicly available, independent, decryption algorithm can be used to decrypt all are part of the UaEM, once the decryption keys are made available, manipulation of the decrypted final output is understood to be impossible.

### 9. Other Embodiments

The invention has now been described with reference to specific embodiments. Other embodiments will be apparent to those of skill in the art. In particular, a client system (or user digital information appliance) is described as an Encrypted Verification Device. However, the digital computing device is meant to be any information appliance for interacting with a remote data application or server system such as a server system employed by a verification service provider as described above, and could include such devices as a personal computer, a cell phone, a personal digital assistant, laboratory or manufacturing equipment, an electronic notebook, all appropriate logic modules. It is understood that the examples and embodiments described herein are for illustrative purposes and that various modifications or changes in light thereof will be suggested by the teachings herein to persons skilled in the art and are to be included within the spirit and purview of this application and scope of the claims.

Furthermore, various different actions can be used to effect communication between a client system and a server system. For example, a voice command may be spoken by the purchaser, a key may be depressed by the purchaser, a button on a client-side scientific device may be depressed by the user, or selection using any pointing device may be effected by the user.

All publications, patents, and patent applications cited herein or filed with this application, including any references filed as part of an Information Disclosure Statement, are incorporated by reference in their entirety.

1. A computer implemented method of verifying a creation date of a document using an un-alterable encrypted media (UaEM) comprising:
receiving a document in an electronic format at a computer system;
encrypting said document using said computer system and an encryption key to generated an encrypted document;
at a server computer system, receiving one or more of said encrypted documents and creating an un-alterable encrypted media containing said one or more encrypted documents;
recording a creation date for said un-alterable encrypted media;
making said un-alterable encrypted media available to one or more interested parties, while withholding a decryption key so that said one or more interested parties are able to independently store a copy of said un-alterable encrypted media without being able to decrypt said encrypted documents until authorized;
when authorized, using a decryption computer system to read an encrypted document from said un-alterable encrypted media, decrypt said encrypted document, and prepare a decrypted output for presentation to a user;
reading said creation date;
using a computer system to present said decrypted output and said creation date to a user;
thereby providing a reliable timestamp for said document.

2. The computer-implemented method according to claim 1 further wherein:
said receiving and said encrypting are performed at a client computer system accessed by a user;
said client computer system contacts a website at a server computer system;
said client computer system uploads said encrypted document to a server computer system.

3. The computer-implemented method according to claim 1 further wherein:
said one or more interested parties are comprise any user of the Internet;
said making said UaEM available comprises placing said UaEM on a publicly available web-site so that any user of the Internet can download and independently store said UaEM.

4. (canceled)

5. The computer-implemented method according to claim 1 further comprising:
recording a creation date of said un-alterable encrypted media in said un-alterable encrypted media;
recording a separate creation date for each of said encrypted documents in said UaEM;
reading both said dates when preparing final output to a user.

6. The computer-implemented method according to claim 1 wherein said document comprises one or more of:
text;
graphics;
video;
audio;
photographs;
interactive media;
executable logic; and
said encrypted document comprises one or more of:
an encrypted text file;
an encrypted audio file;
an encrypted video file;
an encrypted image file;
an encrypted executable file.

7. The computer-implemented method according to claim 1 wherein said receiving comprises one or more of:
accessing said document over a communications channel;
scanning a printed document containing text and/or graphics to produce an electronic format document of said printed document;
digitally encoding an analog recording;
reading one or more electronic format files from a tangible electronic media such as a disk drive or computer memory;
receiving a tangible media from a common carrier, such as U.S. mail.

8-9. (canceled)

10. The computer-implemented method according to claim 1 further comprising:
generating an encryption key using a local computer system;
encrypting said document using said local computer system using said encryption key; and
after said encrypting, uploading said encrypted document to said server computer system, while retaining said encryption key, so that neither said document or said encryption key are ever available to said server computer system.

11. (canceled)

12. The computer-implemented method according to claim 1 wherein said UaEM comprises one or more of:
an encrypted printed document;
an encrypted printed microfiche document;
a non-erasable optical recording medium, such as a laser disc, compact disc, or DVD;
a non-erasable electronic recording medium, such as a read-only electronic memory;
an encrypted electronic file that includes dated and encrypted check-sums and that can be transmitted to a media repository and maintained in local storage and further 1 wherein said UaEM can comprise a journal collection of two or more encrypted documents that are distributed according to a schedule.

13. (canceled)

14. The computer-implemented method according to claim 1 wherein said two or more media repositories comprise one or more of:
public libraries;
university libraries;
government document depositories;
safety deposit boxes;
industrial document depositories.

15. The computer-implemented method according to claim 1 wherein said authorizing comprises one or more of:
receiving a decryption key from an authorized individual or institution;
public release of a decryption key as a result of a confirmed passage of a particular date;
receiving a decryption key as a result of a confirmed instruction from a lawful authority.

16-20. (canceled)

21. The computer-implemented method according to claim 1 further comprising:
providing a printed distribution of said UaEM in a bound printed journal;
providing an electronic distribution of said UaEM in a convenient electronic format.

22. The computer-implemented method according to claim 1 wherein said encryption is performed by a symmetric-key algorithm, such as Advanced Encryption Standard (AES), Data Encryption Standard (DES), Blowfish, Triple DES, Serpent, Twofish.

23. The computer-implemented method according to claim 1 further comprising:
generating a hash-function value for said original document;
including a value of said hash-function with said UaEM or publishing said hash-function value in a periodic journal that is widely distributed and archived; and
thereby providing a secondary means to verify a creation date should said decryption key be lost.

24. (canceled)

25. The computer-implemented method according to claim 1 further wherein:
said server computer system is associated with an verification service provider;
said verification service provider providing any technical or legal expertise needed to verify the creation date of said document.

26. (canceled)

27. A method of a establishing priority of a document using public encrypted disclosure (PED) comprising:
transmitting an encrypted electronic record from a client computer system to a service provider server computer system;
converting said encrypted electronic record to an encrypted physical record using said server computer system, said encrypted physical record able to hold one or more encrypted electronic records;
said server computer system including in said encrypted physical record data indicating a date of submission of encrypted records contained therein;
said encrypted physical record and said data indicating a date of submission in a form that cannot be altered by electronic means;
creating multiple copies of said encrypted physical record;
distributing two or more of said multiple copies of said encrypted physical record by the service provider to publicly accessible locations (e.g., city libraries), so as to allow inspection of said encrypted physical record by any person or party;
wherein distribution of multiple identical encrypted records to a wide variety of disclosed and/or undisclosed locations provides protection against physical tampering of said encrypted physical record;
said service provider advertising the existence of encrypted public archives and availability of a encrypting publishing service to the public.

28-29. (canceled)

30. The method according to claim 29 further comprising:
allowing a user to submit a first body of information establishing conception of an invention at an early date;
allowing a user to submit at a later date a second body of evidence demonstrating actual reduction to practice.
allowing a user to submit dated proof of invention conception;
allowing a user to submit dated proof of knowledge of a trade secret;
allowing a user to submit dated proof of code or algorithm development, or other applications pertinent to copyright law;
allowing a user to submit dated proof of content such as laboratory notebooks;
allowing a user to submit legal agreements or contracts;
allowing a user to submit a document so as to provide the functionality of a notary public;
allowing a user to submit dated proof of the existence of any legal document, such as a signed contract, that otherwise could later be fabricated or forged;
allowing a user to submit a will or other estate-planning document;
allowing a user to submit dated proof of financial transactions, financial agreements; or financial instructions;
allowing a user to submit legal evidence of any form in which a time stamp has a bearing on the validity of that evidence.

31. (canceled)

32. The method according to claim 27 further comprising:
associating two timestamps with each user content submission, a primary software-generated timestamp that is added to the user content upon submission and a secondary distribution time-stamp that is added to a document of multiple user submissions in a journal format;
wherein said secondary time-stamp indicates an interval on which said journal format was distributed.

33. The method according to claim 27 further comprising:
creating at least one publicly accessible record in a tangible physical form that will tend to making any tampering visible and obvious.
further wherein the existence of a publicly accessible record in a highly tangible physical form allows the user to verify that their user content was successfully archived without errors or file corruption, by a verification process that is private and that functions independently of any machine, person, or computational process (i.e., they can compare the file they originally generated on a character-by-character basis to that contained in the public physical record).

34. (canceled)

35. An unalterable encrypted media device comprising:
a tangible optical, magnetic, electronic, or printed media containing two or more encrypted documents requiring different decryption keys.
one or more indicia of a creation date for said media and/or for said two or more encrypted documents;
one or more indicia that would indicate if any part of said tangible optical, magnetic, electronic, or printed media was altered.

36. The device according to claim 35 further comprising:
one or more indicia identifying of each of said two or more encrypted documents; and further wherein:
said two or more encrypted documents are further encrypted together to produce an volume encrypted content on said tangible optical, magnetic, electronic, or printed media; and
said two or more encrypted documents comprise at least two documents that are encrypted independently and received in encrypted form by a service provider who creates said tangible optical, magnetic, electronic, or printed media.

37-38. (canceled)

40. A system of public encrypted disclosure (PED) comprising:
a server system able to receive encrypted documents over a communication channel, prepare a plurality of un-alterable encrypted media (UaEM) volumes, and make said volumes available to two or more interested parties;
a plurality of client devices able to encrypt an original document in an electronic format to generate a plurality of encrypted documents, store a decryption key, and transmit encrypted documents to said server system; and
a plurality of volumes of said un-alterable encrypted media, at least some of said volumes containing two or more encrypted documents received from two or more of said client devices.

41-42. (canceled)

43. The system according to claim 40 further comprising:
one or more repositories of said volumes making said UaEM available to one or more interested parties;
said one or more interested parties are comprise any user of the Internet;
said making said UaEM available comprises placing said UaEM on a publicly available web-site so that any user of the Internet can download and independently store said UaEM;
one or more repositories of said volumes making said UaEM available to one or more interested parties;
said one or more interested parties comprise a selected group of individuals or institutions; and
said making said UaEM available comprises sending an electronic or tangible media communication to said selected group;
said server recording a creation date of said un-alterable encrypted media in said un-alterable encrypted media;
said server recording a separate creation date for each of said encrypted documents in said UaEM.

44-54. (canceled)
